(19) United States
(12) Patent Application Publication
(10) Pub. No.: US 2010/0156008 A1
(43) Pub. Date: Jun. 24, 2010

(54) Programmable System and Method of Spark Plasma Sintering

(75) Inventor: Robert Aalund, Elgin, IL (US)

Correspondence Address: FLIESLER MEYER LLP, 650 CALIFORNIA STREET, 14TH FLOOR, SAN FRANCISCO, CA, 94108, US

(73) Assignee: THERMAL TECHNOLOGY LLC, Santa Rosa, CA (US)

(21) Appl. No.: 12/342,868

(22) Filed: Dec. 23, 2008

(51) Int. Cl. H05H 1/46

(52) U.S. Cl. 264/483; 425/135

(57) ABSTRACT

A programmable system and methods for spark plasma sintering. Embodiments of the present invention allow for detailed waveform settings to be programmed by an operator prior to machine operation during a SPS process. The waveform settings for the machine can be adjusted at any point and can be programmed to have any pattern during the SPS process. Out-gassing patterns can be monitored and analyzed by an operator, who then adjusts the waveform settings for the SPS machine based on an analysis of the out-gassing patterns.

### FIELD OF THE INVENTION

The subject matter described herein relates to a programmable system and methods of spark plasma sintering.

### BACKGROUND

Spark plasma sintering (“SPS”) is a high-speed powder consolidation/sintering technology capable of processing conductive and nonconductive materials. Theories on the spark plasma sintering process vary, but most commonly accepted is the micro-spark/plasma concept which is based on the electrical spark discharge phenomenon wherein a high-amperage, low-voltage pulse current momentarily generates spark plasma at high temperatures (many thousands of ° C.) in fine areas between the particles.

Spark plasma sintering's operational or “monitored” temperatures (200-2400° C.) are commonly 200 to 500° C. lower than with conventional sintering, classifying SPS as a lower-temperature sintering technology. Material processing (pressure and temperature rise and hold time) is completed in short periods of approximately five to twenty-five minutes. The relatively low temperatures combined with fast processing times ensure tight control over grain growth and microstructure.

### SUMMARY

According to the embodiments of the present invention, a programmable system and methods of waveform adjustment are provided for spark plasma sintering. These embodiments achieve improved results while lowering the overall power consumption of the SPS process.

One aspect of the present invention is directed to a method of spark plasma sintering. In an embodiment, material to be consolidated is loaded into a machine that is operable to perform spark plasma sintering. The waveform settings for the machine are programmable by an operator prior to machine operation. The waveform settings for the machine can be adjusted at any point and can be programmed to have any pattern during the SPS process. Once the material is loaded and the machine is programmed, the spark plasma sintering process is started and performed for a preset duration of time.

In another aspect of the present invention, the SPS machine uses higher intensity, higher frequency DC pulse currents near the start of the SPS process, and lower intensity, lower frequency DC pulse currents near the end of the SPS process.

In another aspect of the present invention, out-gassing patterns can be monitored and analyzed by an operator. The operator can then adjust the waveform settings for the SPS machine based on an analysis of the out-gassing patterns.

In another aspect of the present invention, a SPS system includes a SPS machine having a control system and programmable waveform settings. The control system includes a computer-readable storage medium and processor operated thereon, wherein the computer-readable storage medium includes instructions that when executed by the processor cause the SPS system to perform the SPS process in accordance with the programmable waveform settings.

### BRIEF DESCRIPTION OF THE DRAWINGS

The accompanying drawings, which are incorporated into and constitute a part of this specification, illustrate one or more embodiments and, together with the detailed description, serve to explain the principles and implementations of the invention. In the drawings:

FIG. 1 illustrates a block diagram of a spark plasma sintering machine.

FIG. 2 illustrates the ON-OFF pulsed current path within the spark plasma sintering machine during use.

FIG. 3 illustrates a diagram of the surface of powder material particles within the spark plasma sintering machine during use.

FIG. 4 illustrates a waveform from a conventional SPS process.

FIG. 5 illustrates a waveform from a SPS process in accordance with the present invention.

FIG. 6 illustrates a waveform from a SPS process in accordance with the present invention.

FIG. 7 illustrates a graph of stepwise and continuous frequency adjustments as a function of time for a SPS process in accordance with the present invention.

FIG. 8 illustrates a block diagram of a central control system in accordance with the present invention.

### DETAILED DESCRIPTION

Embodiments are described herein in the context of a programmable system and methods of spark plasma sintering. Those of ordinary skill in the art will realize that the following detailed description is illustrative only and is not intended to be in any way limiting. Other embodiments of the present invention will readily suggest themselves to such skilled persons having the benefit of this disclosure. Reference will now be made in detail to implementations of embodiments of the present invention as illustrated in the accompanying drawings. The same reference indicators will be used throughout the drawings and the following detailed description to refer to the same or like parts.

General Description of a SPS Machine and SPS Process

The SPS process is a pressure assisted pulsed current sintering process that utilizes uniaxial force and ON-OFF DC pulse energizing to consolidate powder material. Specifically, the repeated application of an ON-OFF DC pulse voltage and current between powder material particles creates spark discharge and Joule heat points between the material particles, thereby providing high-energy pulses at the point of intergranular bonding. The high frequency of the ON-OFF DC pulse energizing transfers and disperses the spark/Joule heat phenomena throughout the specimen, resulting in a rapid and thorough heat distribution, high homogeneity and consistent densities.

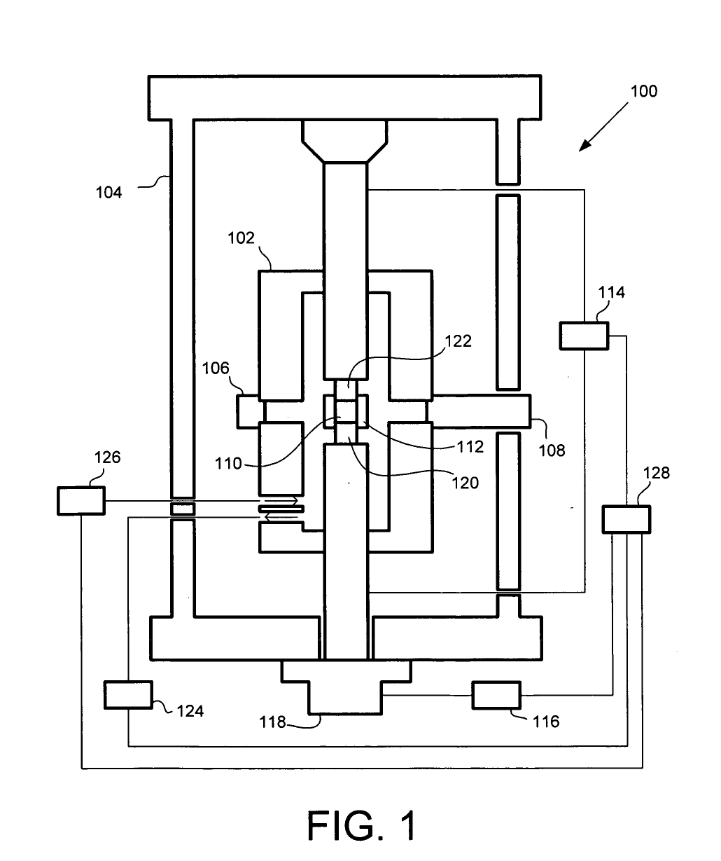

FIG. 1 illustrates a basic block diagram of a typical SPS machine. As illustrated in FIG. 1, the sintering machine, generally numbered 100, includes a vacuum chamber 102 located within the load frame 104 of the sintering machine 100. This sintering machine 100 also includes an observation window 106 and a temperature measurement device 108, both of which are incorporated into the vacuum chamber 102. In use, raw material 110 (typically powder material), which is encased in a die case 112, is placed within the vacuum chamber 102 of the sintering machine 100 wherein the SPS process is performed.

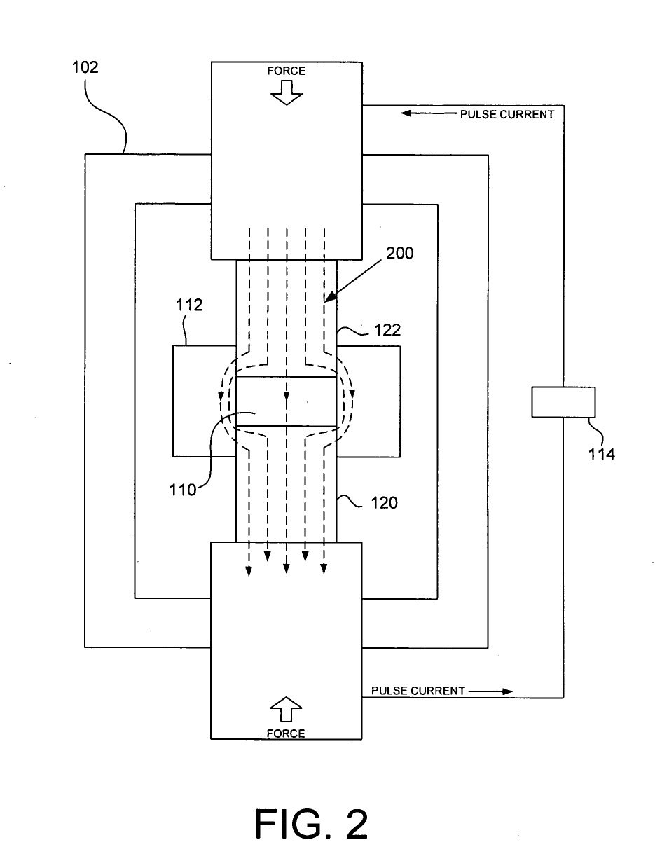

Sintering machine 100 includes a pulsed D.C. power supply 114 that provides the necessary ON-OFF DC pulse voltage and current to the vacuum chamber 102 of the sintering machine 100. FIG. 2 illustrates the ON-OFF pulsed current path 200 through the sintering machine 100 during use. The initiation of the spark discharge in the gap between particles is assisted by fine impurities and gases on and between the surfaces of the particles. The spark discharge creates a momentary, local high-temperature state of up to 10,000° C. causing vaporization of both the impurities and the surfaces of the particles in the area of the spark. Immediately behind the area of vaporization, the particle surface melts. Via electron draw during ON TIME and the vacuum of OFF TIME, these liquidized surfaces are drawn together, creating “necks.” The ongoing “radiant” Joule heat and pressure causes these necks to gradually develop and increase. The radiant heat also causes plastic deformation on the surface of the particles, which is necessary for higher-density applications.

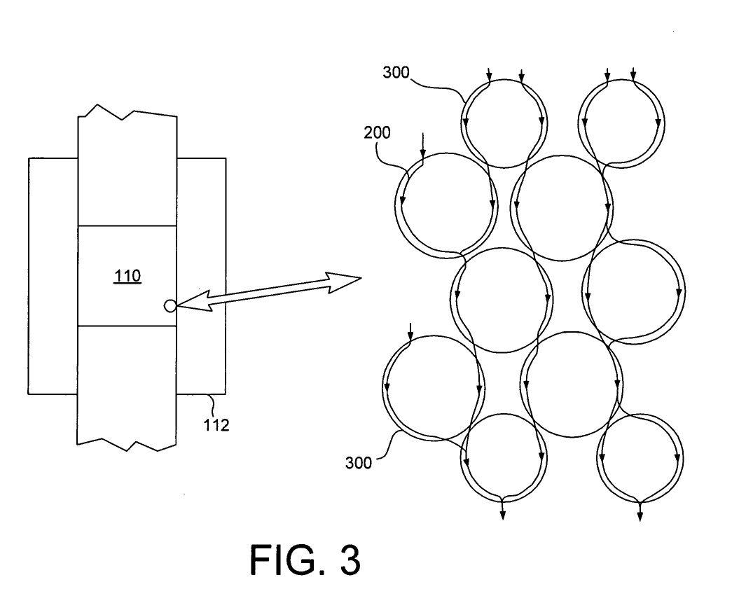

During the spark plasma sintering process, heat is concentrated primarily on the surface of the particles 300 as shown in FIG. 3. Particle growth is limited due to the speed of the process and the fact that only the surface temperature of the particles rises rapidly. The entire process—from powder to finished bulk sample—is completed quickly, with high uniformity and without changing the particles' characteristics.

Force (pressure) also plays an important and predictable role in curbing particulate growth and influencing overall densities. Force multiplies spark initiation (diffusion) throughout the sample as the material moves under pressure, especially during out-gassing stages. Both too much and too little pressure can negatively influence the process. In large samples where high density is required, force is commonly increased in stages to enhance out-gassing and electrical diffusion. Accordingly, accurate manipulation of force can enhance the SPS process.

Referring back to FIG. 1, the sintering machine 100 is further illustrated as including a hydraulic power unit 116, a hydraulic press cylinder 118, a lower punch 120, an upper punch 122 and load cell 130. The raw material 110 to be consolidated can be placed within the die case 112 between the lower punch 120 and the upper punch 122, all within the vacuum chamber 102 of the sintering machine 100 during use. The hydraulic power unit 116 provides power to the hydraulic press cylinder 118, which in turn is used to move the lower punch 120 and the upper punch 122 up and down to manipulate the mechanical force (or pressure) applied to the raw material 110 during the SPS process. The load cell 130 can be used to measure the force applied to the raw material 110.

The SPS machine 100 also includes a vacuum pump 124, which allows the SPS machine to operate under negative atmospheric pressure. Inert gas 126 can also be injected into the vacuum chamber 102 of the SPS machine 100 during the SPS process.

FIG. 1 further illustrates a central control system 128 that is used to control the different aspects of the sintering machine 100 during use. The control system 128 is used to control the pulsed D.C. power supply 114, the hydraulic power unit 116, the vacuum pump 124, as well as control the amount of inert gas 126 introduced to the vacuum chamber 102 during use.

Standard Set-Up Approach to SPS

Commonly SPS system parameters are set prior to machine operation. These preset system parameters may include, among other things, pressure ramp-up and hold settings, temperature ramp-up and hold settings and DC pulse current settings (or waveform settings).

While the specific pressure ramp-up and hold settings for given SPS machine will differ from machine to machine, typically, a first minimum force will be applied to the material to be sintered at the outset of the SPS process while the vacuum is activated. Once the vacuum is activated and the SPS process is started, a second constant full force (e.g., 60 MPa) will be applied to the material being sintered throughout the duration of the process.

With respect to the temperature ramp-up and hold settings employed by a typical SPS machine, once the process is started, there will be a ramp up period for the internal temperature of the SPS machine to reach its maximum operating temperature per a given sample material (e.g., 1400° C. in 6 minutes). This temperature ramp up can occur continuously or in stages. Once the maximum operating temperature is reached, the SPS machine will operate at that temperature throughout the duration of the process (e.g., 1400° C. for 4 minutes).

With respect to a SPS machine's waveform settings, these settings may include, among other things, independent controls of: (1) ON and OFF times for the DC pulse currents; (2) the intensity characteristics of the DC pulse currents (i.e., the amplitude of the current); (3) the on-time hold times for the DC pulse currents; and (4) positive and negative DC pulse current characteristics utilized during the SPS process.

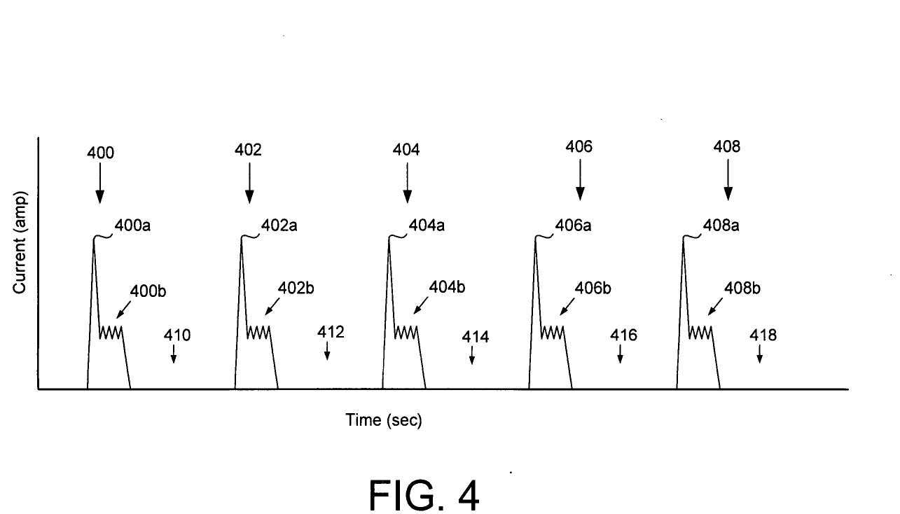

FIG. 4 illustrates a conceptual representation of a waveform for a conventional SPS process. As shown in FIG. 4, DC pulse current 400 is illustrated as having an initial current spike 400a followed by an on-time hold current 400b. DC pulse current 400 is followed by off-time period 410 before DC pulse current 402 is applied. The pattern of ON-OFF pulse energizing continues until the last DC pulse current is applied, which is DC pulse current 408 in FIG. 4. As shown in FIG. 4, the conventional method of operating a SPS machine involves maintaining constant (i.e., uniform or homogeneous) DC pulse current settings throughout the SPS process. Accordingly, the initial current spike 400a and on-time hold current 400b characteristics for DC pulse current 400 are virtually identical as those found for DC pulse currents 402, 404, 406, 408. The off-time periods 410, 412, 414, 416, 418 are also substantially identical throughout the process.

Furthermore, for a typical SPS machine, detailed waveform adjustments are not programmable by an operator. Instead, only basic waveform adjustments can be made by an operator. For example, the ON and OFF times for the DC pulse currents may be changed by an operator, but those changes will remain constant throughout the duration of the entire process. Moreover, these basic adjustments must be made manually on the machine itself. Consequently, while the conventional approach to SPS operation is capable of sintering material, what is needed is a more efficient and flexible method of spark plasma sintering that results in faster and improved results while lowering overall power consumption.

Programmable Waveform

What is disclosed herein is a novel programmable system and methods of spark plasma sintering, wherein detailed waveform settings can be programmed by an operator via an offline, or built in, programming system prior to machine operation.

Breaking away from the conventional approach to SPS operation, the present invention allows the operator of the SPS machine to program detailed adjustments to waveform settings prior to machine operation. This is a novel departure from the current approach to spark plasma sintering. By allowing the operator to program detailed adjustments to waveform settings, the SPS machine is not limited to basic waveform adjustments that result in homogeneous waveform patterns. Thus, the operator of the SPS machine is able to optimize the SPS process for any given powder material.

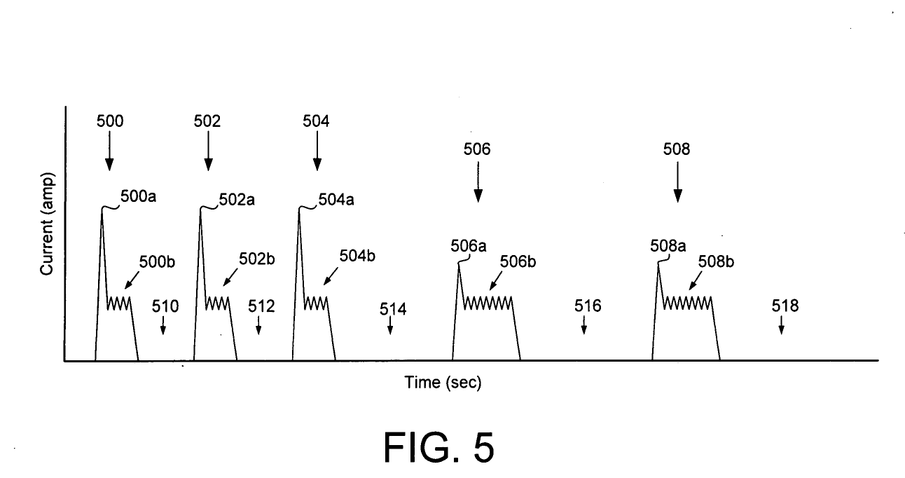

FIG. 5 illustrates a conceptual representation of a waveform in accordance with an embodiment of the present invention. Similar to the conventional waveform illustrated in FIG. 4, FIG. 5 illustrates a first DC pulse current 500 that includes an initial current spike 500a, an on-time hold current 500b and a subsequent off-time period 510. However, unlike the conventional profile illustrated in FIG. 4, the DC pulse currents illustrated in FIG. 5 include varied (i.e., heterogeneous, not constant or uniform) waveform characteristics. In this embodiment, the initial DC pulse currents 500, 502, 504 have relatively higher initial current spikes 500a, 500b, 500c and shorter on-time hold periods 500b, 502b, 504b than DC pulse currents 506, 508. Frequency adjustments to the waveform are also illustrated in FIG. 5, wherein off-time periods 510, 512 are shorter than off-time period 514, 516.

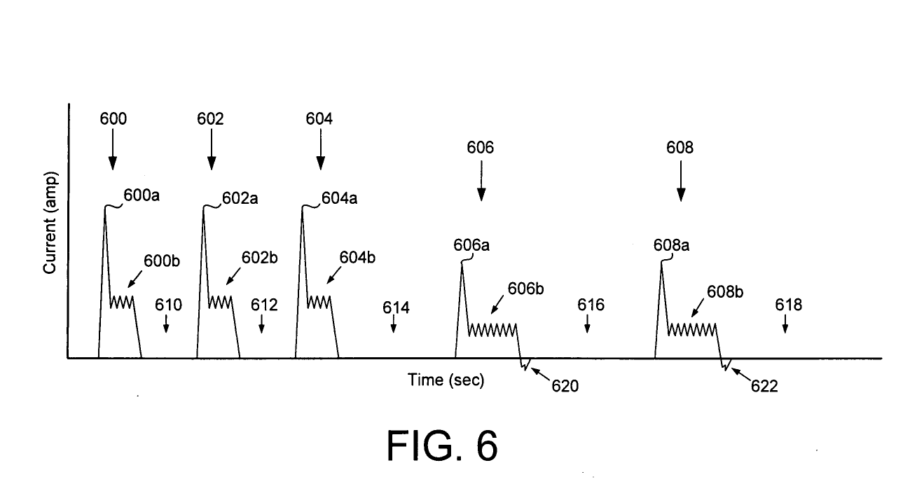

FIG. 6 illustrates another conceptual representation of a waveform in accordance with an embodiment of the present invention. The waveform of FIG. 6 is substantially similar to the waveform of FIG. 5. The waveform of FIG. 6, however, shows that adjustments to the amplitudes of the on-time hold periods can also be programmed prior to machine operation. Accordingly, the amplitudes for on-time hold periods 600b, 602b, 604b are greater than the amplitudes of on-time hold periods 606b, 608b. FIG. 6 further shows that negative (−) currents 620, 622 can also be programmed prior to machine operation.

In an embodiment of the invention, an operator of a SPS machine will be able to program the SPS machine to produce the types of waveform patterns illustrated in FIGS. 5 & 6. In the preferred embodiment of the invention, higher intensity, higher frequency DC pulse currents will be used at the beginning of the SPS process to induce rapid spark diffusion. Once rapid spark diffusion has been induced, lower intensity, lower frequency DC pulse currents will be applied by the SPS machine. In an embodiment, once rapid spark diffusion has been induced, only a minimal number of DC pulse currents will be applied by the SPS machine, instead relying on resistance heating to complete the sintering process. These types of optimized methods for operating the SPS process are effective for better diffusion of heat energy in the early stages of neck formation and more efficient resistive heat for achieving full densification while also reducing the overall power consumption by the system.

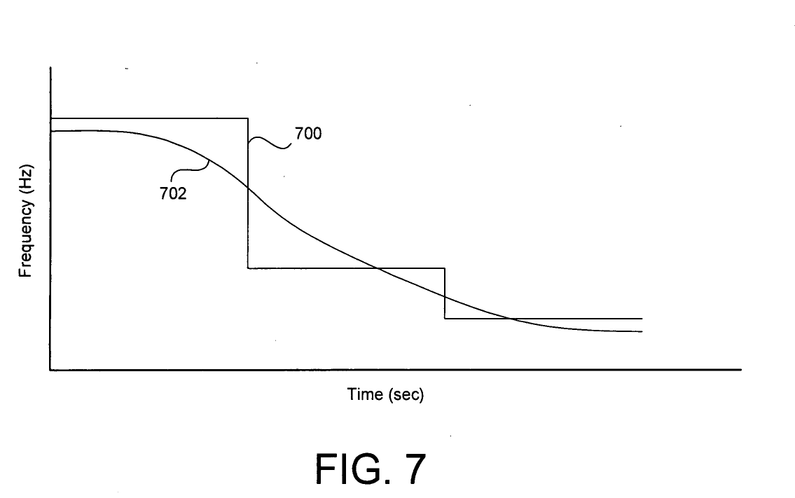

In an embodiment, the waveform adjustments are made in a stepwise manner having one or more discrete step changes. In another embodiment, the waveform adjustments are continuously made throughout the SPS process in accordance with the preset waveform settings. For example, FIG. 7 graphs conceptual representations of stepwise 700 and continuous 702 frequency adjustments as a function of time for a given SPS process in accordance with embodiments of the present invention. While various examples of waveform adjustments have been provided herein, it is noted that a SPS machine may be programmed to include any combination of waveform settings as envisioned by one having an ordinary skill in the art having the benefit of this disclosure.

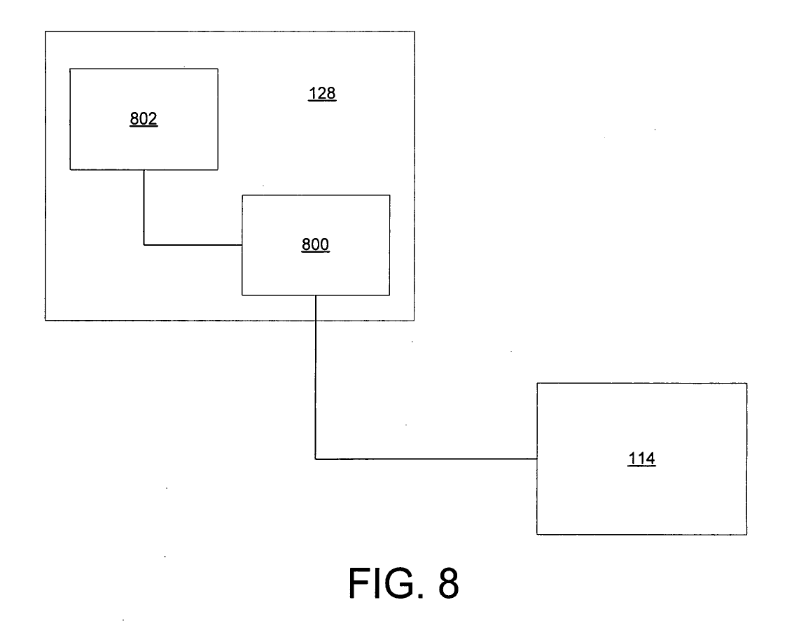

FIG. 8 illustrates a block diagram of an embodiment of a SPS system that allows an operator program any basic waveform adjustments according to the present invention. In this embodiment, the central control system 128 includes at least one processor 800 operatively coupled to the pulsed D.C. power supply 114, which is incorporated into the SPS machine 100 (as shown in FIG. 1). The processor 800 is also coupled to a computer-readable storage medium (media) 802 having computer-executable instructions stored thereon/in that when executed by the processor cause the SPS machine to perform any of the processes of the present invention. In an embodiment, the computer-readable storage medium 802 includes preset instructions stored thereon/in that controls the pulsed D.C. power supply 114 of the SPS machine. In this embodiment, the control system 128 includes a user interface for receiving user input. The user interface allows a user to make adjustments to the present waveform settings prior to the SPS process. In an embodiment, the control system 128 may reside directly in the SPS machine 100. In another embodiment, the control system 128 may reside outside of the SPS machine 100, for example, in a general purpose/specialized computer.

In an embodiment, the storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Embodiments of the present invention include software, stored on any one of the computer readable medium (media), for controlling both the hardware of the general purpose/specialized computer, and for enabling the computer or processor to interact with a human operator or other mechanism utilizing the results of the present invention. Such software may include, but is not limited to, device drivers, operating systems, and user applications. Ultimately, such computer readable media further includes software for executing the present invention, as described above. Appropriate software coding for the computer-readable program can readily be prepared by skilled programmers based on the teachings of the present disclosure, as will be apparent to those skilled in the software art.

Method of Determining Waveform Adjustments

The specific waveform adjustments to be programmed into a SPS machine will in large part depend upon the material being sintered. Consequently, in order to assist an operator to program appropriate waveform adjustments into the SPS machine, a novel method of determining waveform adjustments is set forth as follows.

During a typical SPS process, as heat increases, fine impurities and gases located on and between the surfaces of the particles being sintered are released. This release of impurities and gases is known as “out-gassing.” These gasses can be monitored via a vacuum gage or vacuum data acquisition. Out gassing “spikes” occur at points where there is high sintering “effect” in the material. If the material, sample size, and settings are repeated, the out-gassing pattern will also repeat. In an embodiment of the invention, these out-gassing patterns can be used to determine where and how waveform adjustments should be handled during future cycles.

The foregoing description of preferred embodiments of the present invention has been provided for the purposes of illustration and description. It is not intended to be exhaustive or to limit the invention to the precise forms disclosed. Many embodiments were chosen and described in order to best explain the principles of the invention and its practical application, thereby enabling others skilled in the art to understand the invention for various embodiments and with various modification that are suited to the particular use contemplated. It is intended that the scope of the invention be defined by the claims and their equivalents.

1. A method of spark plasma sintering, comprising:
in any order:
a. loading material into a machine that is operable to perform spark plasma sintering;
b. programming waveform settings for said machine, wherein said waveform settings are programmable by an operator prior to machine operation; wherein said waveform settings are automatically varied by said machine during operation;
starting a spark plasma sintering process to sinter said material using said machine, wherein DC pulse currents are used to sinter said material; and
ending said spark plasma sintering process for said material.

2. The method of claim 1, wherein controls of said waveform settings comprise controls of:
on and off times for said DC pulse currents;
intensity characteristics of said DC pulse currents; and
on-time hold times for said DC pulse currents.

3. The method of claim 1, wherein higher intensity and higher frequency DC pulse currents are used at the beginning of said spark plasma sintering process than at the end of said spark plasma sintering process.

4. The method of claim 1, wherein adjustments to said waveform settings are made in a stepwise manner having one or more discrete step changes.

5. The method of claim 1, wherein adjustments to said waveform settings are continuously made throughout the spark plasma sintering process in accordance with said waveform settings.

6. The method of claim 1, wherein the step of programming waveform settings is performed by said operator on a computer that resides outside of said machine.

7. The method of claim 1, wherein the step of programming waveform settings is performed by said operator directly on said machine.

8. The method of claim 1, further comprising:
monitoring out-gassing patterns for said material; and
programming said waveform settings for said machine based on said out-gassing patterns.

9. A system for spark plasma sintering, comprising:
a machine that is operable to perform spark plasma sintering, wherein said machine is coupled to a control system, said control system comprising programmable waveform settings for said machine;
wherein said waveform settings are programmable by an operator prior to machine operation, wherein said waveform settings are automatically varied by said machine during operation;
said control system comprising a computer computer-readable medium coupled to a processor, said computer-readable medium having computer-executable instructions stored thereon that when executed by the processor cause the machine to perform the steps comprising:
starting a spark plasma sintering process to sinter said material using said machine, wherein DC pulse currents are used to sinter said material; and
ending said spark plasma sintering process for said material.

10. The system of claim 9 wherein controls of said waveform settings comprise controls of:
on and off times for said DC pulse currents;
intensity characteristics of said DC pulse currents; and
on-time hold times for said DC pulse currents.

11. The system of claim 9, wherein higher intensity and higher frequency DC pulse currents are used at the beginning of said spark plasma sintering process than at the end of said spark plasma sintering process.

12. The system of claim 9, wherein adjustments to said waveform settings are made in a stepwise manner having one or more discrete step changes.

13. The system of claim 9, wherein adjustments to said waveform settings are continuously made throughout the spark plasma sintering process in accordance with said waveform settings.

14. The system of claim 9, wherein said waveform settings are programmed by said operator on a computer that resides outside of said machine.

15. The system of claim 9, wherein said waveform settings are programmed by said operator directly on said machine.

16. The system of claim 9, wherein said machine monitors out-gassing patterns during said spark plasma sintering process, wherein said waveform settings are programmed based on said out-gassing patterns.
